(19) United States
(12) Patent Application Publication
(10) Pub. No.: US 2004/0117318 A1
(43) Pub. Date: Jun. 17, 2004

(54) Portable token controlling trusted environment launch

(76) Inventor: David W. Grawrock, Aloha, OR (US)

Correspondence Address: Jeffrey B. Huter, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/321,957

(22) Filed: Dec. 16, 2002

(51) Int. Cl. G06F 17/60; H04K 1/00; H04L 9/00

(52) U.S. Cl. 705/66

(57) ABSTRACT

Methods, apparatus and machine readable medium are described that prevent successfully launching a trusted environment without providing the computing device with an appropriate portable token. In one embodiment, the computing device stores information on the portable token that is required in order to launch the trusted environment. In another embodiment, information that is required to launch the trusted environment is encrypted with a key that has been sealed to a portable token. Accordingly, the required information may only be decoded if the portable token is present.

### BACKGROUND

The Trusted Platform Computing Alliance (TPCA) Main Specification, Version 1.1 b, 22 Feb. 2002 (hereinafter “TCPA SPEC”) describes a Trusted Platform Module (TPM) or token that is affixed to and/or otherwise irremovable from a computing device or platform. This fixed token supports auditing and logging of software processes, platform boot integrity, file integrity, and software licensing. Further, the fixed token provides protected storage where items can be protected from exposure or improper use, and provides an identity that may be used for attestation. These features encourage third parties to grant the computing device or platform access to information that would otherwise be denied.

Third parties may utilize remote computing devices to establish a level of trust with the computing device using the attestation mechanisms of the fixed token. However, the processes by which this level of trust is established typically require that a remote computing device of the third party perform complex calculations and participate in complex protocols with the fixed token. However, a local user of the platform may also want to establish a similar level of trust with the local platform or computing device. It is impractical, however, for a local user to perform the same complex calculations and participate in the same complex protocols with the fixed token as the remote computing devices in order to establish trust in the computing device.

Further, the fixed token may be used by a computing device to establish a trust environment in which secrets may be protected. In particular, the trusted environment may encrypt such secrets such that only the trusted environment may decrypt the secrets. Accordingly, untrusted environments are unable to obtain such secrets without requesting the trusted environment for the secrets. While this generally provides an isolated container for protecting secrets, a local user of the computing device may want further assurances that the computing device will not release secrets of a trusted environment without the authorization of the user or the user being present.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference numerals have been repeated among the figures to indicate corresponding or analogous elements.

FIG. 1 illustrates an example computing device comprising a fixed token and a portable token.

FIG. 2 illustrates an example fixed token and an example portable token of FIG. 1.

FIG. 3 illustrates an example trusted environment that may be implemented by the computing device of FIG. 1.

FIG. 4 illustrates an example sealed key blob and an example protected key blob that may be used by the computing device of FIG. 1 for local attestation.

FIG. 5 illustrates an example method to create the protected key blob of FIG. 4.

FIG. 6 illustrates an example method to load keys of the protected key blob of FIG. 4.

FIG. 7 illustrates a basic timeline for establishing the trusted environment of FIG. 3.

FIG. 8 illustrates a method of protecting launch of the trusted environment of FIG. 3 using the portable token of FIG. 1.

### DETAILED DESCRIPTION

In the following detailed description, numerous specific details are described in order to provide a thorough understanding of the invention. However, the present invention may be practiced without these specific details. In other instances, well-known methods, procedures, components and circuits have not been described in detail so as not to obscure the present invention. Further, example sizes/models/values/ranges may be given, although some embodiments may not be limited to these specific examples.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Further, the term “blob” (binary large object) is commonly used in the database arts to refer to any random large block of bits that needs to be stored in a database in a form that cannot be interpreted by the database itself. However, as used herein, the term “blob” is intended to have a much broader scope. In particular, the term “blob” is intended to be a broad term encompassing any grouping of one or more bits regardless of structure, format, representation, or size.

Furthermore, the verb “hash” and related forms are used herein to refer to performing an operation upon an operand or message to produce a value or a “hash”. Ideally, the hash operation generates a hash from which it is computationally infeasible to find a message with that hash and from which one cannot determine any usable information about a message with that hash. Further, the hash operation ideally generates the hash such that determining two messages which produce the same hash is computationally impossible. While the hash operation ideally has the above properties, in practice one way functions such as, for example, the Message Digest 5 algorithm (MD5) and the Secure Hashing Algorithm 1 (SHA-1) generate hash values from which deducing the message are difficult, computationally intensive, and/or practically infeasible.

Moreover, the terms “first”, “second”, “third”, etc. are used herein as labels to distinguish between similarly named components and/or operations. In particular, such terms are not used to signify and are not meant to signify an ordering of components and/or operations. Further, such terms are not used to signify and are not meant to signify one component and/or operation having greater importance than another.

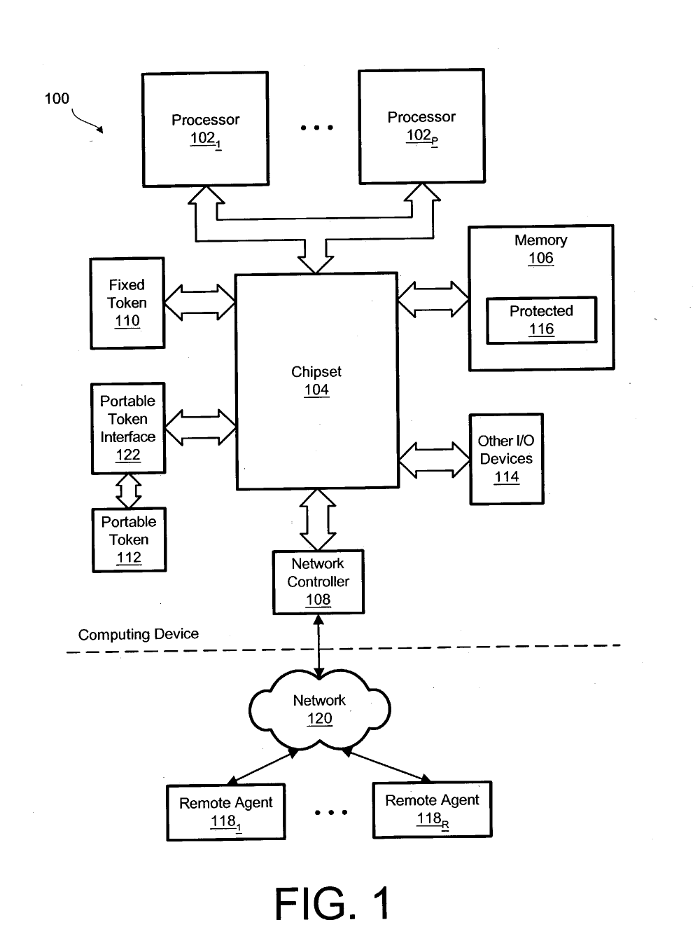

Now referring to FIG. 1, an example computing device 100 is shown. The computing device 100 may comprise one or more processors 102₁ . . . 102_{P}. The processors 102₁ . . . 102_{P} may support one or more operating modes such as, for example, a real mode, a protected mode, a virtual 8086 mode, and a virtual machine extension mode (VMX mode). Further, the processors 102₁ . . . 102_{P} may support one or more privilege levels or rings in each of the supported operating modes. In general, the operating modes and privilege levels of processors 102₁ . . . 102_{P} define the instructions available for execution and the effect of executing such instructions. More specifically, the processors 102₁ . . . 102_{P} may be permitted to execute certain privileged instructions only if the processors 102₁ . . . 102_{P} is in an appropriate mode and/or privilege level.

The chipset 104 may comprise one or more integrated circuit packages or chips that couple the processors 102₁ . . . 102_{P} to memory 106, a network interface 108, a fixed token 110, a portable token 112, and other I/O devices 114 of the computing device 100 such as, for example, a mouse, keyboard, disk drive, video controller, etc. The chipset 104 may comprise a memory controller (not shown) for writing and reading data to and from the memory 106. Further, the chipset 104 and/or the processors 102₁ . . . 102_{P} may define certain regions of the memory 106 as protected memory 116. In one embodiment, the processors 102₁ . . . 102_{P} may access the protected memory 116 only when in a particular operating mode (e.g. protected mode) and privilege level (e.g. OP).

The network interface 108 generally provides a communication mechanism for the computing device 100 to communicate with one or more remote agents 118₁ . . . 118_{R} (e.g. certification authorities, retailers, financial institutions) via a network 120. For example, the network interface 108 may comprise a Gigabit Ethernet controller, a cable modem, a digital subscriber line (DSL) modem, plain old telephone service (POTS) modem, etc. to couple the computing device 100 to the one or more remote agents 118₁ . . . 118_{R}.

The fixed token 110 may be affixed to or incorporated into the computing device 100 to provide some assurance to remote agents 118₁ . . . 118_{R} and/or a local user that the fixed token 110 is associated only with the computing device 100. For example, the fixed token 110 may be incorporated into one of the chips of the chipset 104 and/or surface mounted to the mainboard (not shown) of the computing device 100. In general, the fixed token 110 may comprise protected storage for metrics, keys and secrets and may perform various integrity functions in response to requests from the processors 102₁ . . . 102_{P} and the chipset 104. In one embodiment, the fixed token 110 may store metrics in a trusted manner, may quote metrics in a trusted manner, may seal secrets to a particular environment (current or future), and may unseal secrets to the environment to which they were sealed. Further, the fixed token 110 may load keys of a sealed key blob and may establish sessions that enable a requester to perform operations using a key associated with the established session.

The portable token 112 may establish a link to the processors 102₁ . . . 102_{P} via a portable token interface 122 of the computing device 100. The portable token interface 122 may comprise a port (e.g. USB port, IEEE 1394 port, serial Port, parallel port), a slot (e.g. card reader, PC Card slot, etc.), transceiver (e.g. RF transceiver, Infrared transceiver, etc.), and/or some other interface mechanism than enables the portable token 112 to be easily coupled to and removed from the computing device 100. Similar to the fixed token 110, the portable token 112 may comprise protected storage for keys and secrets and may perform various integrity functions in response to requests from the processors 102₁ . . . 102_{P} and the chipset 104. In one embodiment, the portable token 112 may load keys of a sealed key blob, and may establish sessions that enable a requester to perform operations using a key associated with the established session. Further, the portable token 112 may change usage authorization data associated with a sealed key blob, and may return a sealed key blob of a protected key blob after determining that a requester is authorized to receive the sealed key blob.

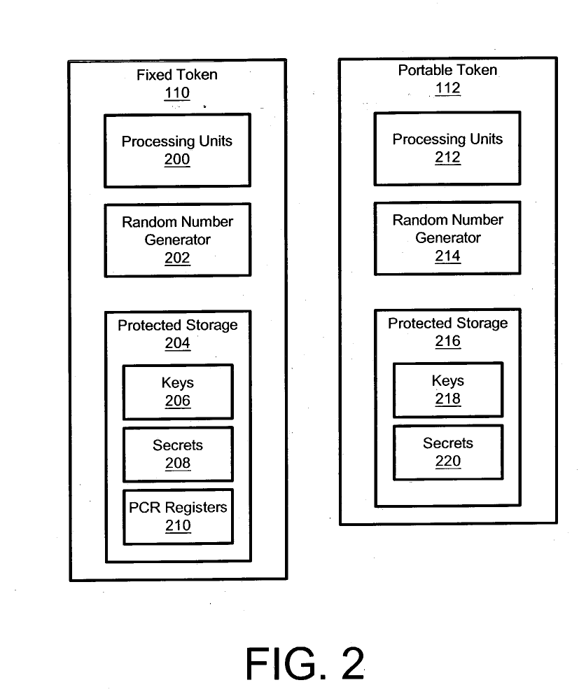

As illustrated in FIG. 2, the fixed token 110 may comprise one or more processing units 200, a random number generator 202, and protected storage 204 which may comprise keys 206, secrets 208, and/or one or more platform configuration register (PCR) registers 210 for metrics. Similarly, the portable token 112 may comprise one or more processing units 212, a random number generator 214, and protected storage 216 which may comprise keys 218 and/or secrets 220. The processing units 200, 212 may perform integrity functions for the computing device 100 such as, for example, generating and/or computing symmetric and asymmetric keys. In one embodiment, the processing units 200, 212 may use the generated keys to encrypt and/or sign information. Further, the processing units 200, 212 may generate the symmetric keys based upon an AES (Advanced Encryption Standard), a DES (Data Encryption Standard), 3DES (Triple DES), or some other symmetric key generation algorithm that has been seeded with a random number generated by the random number generators 202, 214. Similarly, the processing units 200, 212 may generate the asymmetric key pairs based upon an RSA (Rivest-Shamir-Adleman), EC (Elliptic Curve), or some other asymmetric key pair generation algorithm that has been seeded with a random number generated by the random number generators 202, 214.

In one embodiment, both the fixed token 110 and the portable token 112 may generate immutable symmetric keys and/or asymmetric key pairs from symmetric and asymmetric key generation algorithms seeded with random numbers generated by their respective random number generator 202, 214. In general, these immutable keys are unalterable once the tokens 110, 112 activate them. Since the immutable keys are unalterable after activation, the immutable keys may be used as part of a mechanism to uniquely identify the respective token 110, 112. Besides the immutable keys, the processing units 200, 212 may further generate one or more supplemental asymmetric key pairs in accordance with an asymmetric key generation algorithm. In an example embodiment, the computing device 100 may generate supplemental asymmetric key pairs as needed whereas the immutable asymmetric key pairs are immutable once activated. To reduce exposure of the immutable asymmetric key pairs to outside attacks, the computing device 100 typically utilizes its supplemental asymmetric key pairs for most encryption, decryption, and signing operations. In particular, the computing device 100 typically provides the immutable public keys to only a small trusted group of entities such as, for example, a certification authority. Further, the fixed token 110 of the computing device 100 in one embodiment never provides a requester with an immutable private key and only provides a requester with a mutable private key after encrypting it with one of its immutable public keys and/or one of its other supplemental asymmetric keys.

Accordingly, an entity may be reasonably assured that information encrypted with one of the supplemental public keys or one of the immutable public keys may only be decrypted with the respective token 110, 112 or by an entity under the authority of the respective token 110, 112. Further, the portable token 112 may provide some assurance to the computing device 100 and/or remote agents 118₁ . . . 118_{R} that a user associated with the portable token 112 is present or located at or near the computing device 100. Due to uniqueness of the portable token 112 and an assumption that the user is in control of the portable token 112, the computing device 100 and/or remote agents 118₁ . . . 118_{R} may reasonably assume that the user of the portable token 112 is present or the user has authorized someone else to use the portable token 112.

The one or more PCR registers 210 of the fixed token 110 may be used to record and report metrics in a trusted manner. To this end, the processing units 200 may support a PCR quote operation that returns a quote or contents of an identified PCR register 210. The processing units 200 may also support a PCR extend operation that records a received metric in an identified PCR register 210. In particular, the PCR extend operation may (i) concatenate or append the received metric to an metric stored in the identified PCR register 210 to obtain an appended metric, (ii) hash the appended metric to obtain an updated metric that is representative of the received metric and previously metrics recorded by the identified PCR register 210, and (iii) store the updated metric in the PCR register 210.

The fixed token 110 and the portable token 112 in one embodiment both provide support for establishing sessions between a requester and the tokens 110, 112. In particular, the fixed token 110 and the portable token 112 in one embodiment both implement the Object-Specific Authentication Protocol (OS-AP) described in the TCPA SPEC to establish sessions. Further, both the fixed token 110 and the portable token 112 both implement the TPM_OSAP command of the TCPA SPEC results in the token 110, 112 establishing a session in accordance with the OS-AP protocol. In general, the OS-AP protocol requires that a requester provide a key handle that identifies a key of the token 110, 112. The key handle is merely a label that indicates that the key is loaded and a mechanism to locate the loaded key. The token 110, 112 then provides the requester with an authorization handle that identifies the key and a shared secret computed from usage authorization data associated with the key. When using the session, the requester provides the token 110, 112 with the authorization handle and a message authentication code (MAC) that both provides proof of possessing the usage authorization data associated with the key and attestation to the parameters of the message/request. In one embodiment, the requester and tokens 110, 112 further compute the authentication code based upon a rolling nonce paradigm where the requester and tokens 110, 112 both generate random values or nonces which are included in a request and its reply in order to help prevent replay attacks.

The processing units 200 of the fixed token 110 may further support a seal operation. The seal operation in general results in the fixed token 110 sealing a blob to a specified environment and providing a requesting component such as, for example, the monitor 310, the kernel 332, trusted applets 334, operating system 322, and/or application 324 with the sealed blob. In particular, the requesting component may establish a session for an asymmetric key pair of the fixed token 110. The requesting component may further provide the fixed token 110 via the established session with a blob to seal, one or more indexes that identify PCR registers 210 to which to seal the blob, and expected metrics of the identified PCR registers 210. The fixed token 110 may generate a seal record that specifies the environment criteria (e.g. quotes of identified PCR registers 210), a proof value that the fixed token 110 may later use to verify that the fixed token 110 created the sealed blob, and possibly further sensitive data to which to seal the blob. The fixed token 110 may further hash one or more portions of the blob to obtain a digest value that attests to the integrity of the one or more hashed portions of the blob. The fixed token 110 may then generate the sealed blob by encrypting sensitive portions of the blob such as, usage authorization data, private keys, and the digest value using an asymmetric cryptographic algorithm and the public key of the established session. The fixed token 110 may then provide the requesting component with the sealed blob.

The processing units 200 of the fixed token 110 may also support an unseal operation. The unseal operation in general results in the fixed token 110 unsealing a blob only if the blob was sealed with a key of the fixed token 110 and the current environment satisfies criteria specified for the sealed blob. In particular, the requesting component may establish a session for an asymmetric key pair of the fixed token 110, and may provide the fixed token 110 with a sealed blob via the established session. The fixed token 110 may decrypt one or more portions of the sealed blob using the private key of the established session. If the private key corresponds to the public key used to seal the sealed blob, then the fixed token 110 may obtain plain-text versions of the encrypted data from the blob. Otherwise, the fixed token 110 may encounter an error condition and/or may obtain corrupted representations of the encrypted data. The fixed token 110 may further hash one or more portions of the blob to obtain a computed digest value for the blob. The fixed token 110 may then return the blob to the requesting component in response to determining that the computed digest value equals the digest value obtained from -the sealed blob, the metrics of the PCR registers 210 satisfy the criteria specified by the seal record obtained from the sealed blob, and the proof value indicates that the fixed token 110 created the sealed blob. Otherwise, the fixed token 110 may abort the unseal operation and erase the blob, the seal record, the digest value, and the computed digest value from the fixed token 110.

The above example seal and unseal operations use a public key to seal a blob and a private key to unseal a blob via an asymmetric cryptographic algorithm. However, the fixed token 110 may use a single key to both seal a blob and unseal a blob using a symmetric cryptographic algorithm. For example, the fixed token 110 may comprise an embedded key that is used to seal and unseal blobs via a symmetric cryptographic algorithm, such as, for example DES, 3DES, AES, and/or other algorithms.

It should be appreciated that the fixed token 110 and portable token 112 may be implemented in a number of different manners. For example, the fixed token 110 and portable token 112 may be implemented in a manner similar to Trusted Platform Module (TPM) described in detail in the TCPA SPEC. However, a cheaper implementation of the portable token 112 with substantially fewer features and functionality than the TPM of the TCPA SPEC may be suitable for some usage models such as local attestation. Further, the fixed token 110 and the portable token 112 may establish sessions and/or authorize use of its keys in a number of different manners beyond the OS-AP protocol described above.

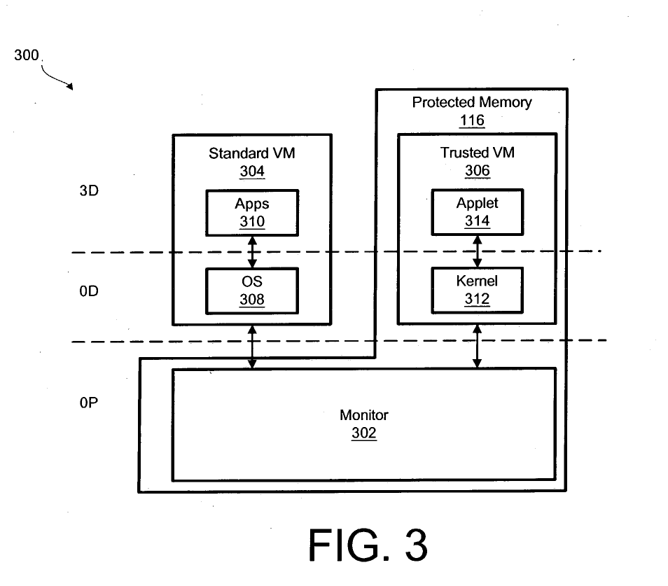

An example trusted environment 300 is shown in FIG. 3. The computing device 100 may utilize the operating modes and the privilege levels of the processors 102₁ . . . 102_{P} to establish the trusted environment 300. As shown, the trusted environment 300 may comprise a trusted virtual machine kernel or monitor 302, one or more standard virtual machines (standard VMs) 304, and one or more trusted virtual machines (trusted VMs) 306. The monitor 302 of the trusted environment 300 executes in the protected mode at the most privileged processor ring (e.g. OP) to manage security and privilege barriers between the virtual machines 304, 306.

The standard VM 304 may comprise an operating system 308 that executes at the most privileged processor ring of the VMX mode (e.g. OD), and one or more applications 310 that execute at a lower privileged processor ring of the VMX mode (e.g. 3D). Since the processor ring in which the monitor 302 executes is more privileged than the processor ring in which the operating system 308 executes, the operating system 308 does not have unfettered control of the computing device 100 but instead is subject to the control and restraints of the monitor 302. In particular, the monitor 302 may prevent the operating system 308 and its applications 310 from accessing protected memory 116 and the fixed token 110.

The monitor 302 may perform one or more measurements of the trusted kernel 312 such as a hash of the kernel code to obtain one or more metrics, may cause the fixed token 110 to extend an identified PCR register 210 with the metrics of the trusted kernel 312, and may record the metrics in an associated PCR log stored in protected memory 116. Further, the monitor 302 may establish the trusted VM 306 in protected memory 116 and launch the trusted kernel 312 in the established trusted VM 306.

Similarly, the trusted kernel 312 may take one or more measurements of an applet or application 314 such as a hash of the applet code to obtain one or more metrics. The trusted kernel 312 via the monitor 302 may then cause the fixed token 110 to extend an identified PCR register 210 with the metrics of the applet 314. The trusted kernel 312 may further record the metrics in an associated PCR log stored in protected memory 116. Further, the trusted kernel 312 may launch the trusted applet 314 in the established trusted VM 306 of the protected memory 116.

In response to initiating the trusted environment 300 of FIG. 3, the computing device 100 may further record metrics of the monitor 302, the processors 102₁ . . . 102_{P}, the chipset 104, BIOS firmware (not shown), and/or other hardware/software components of the computing device 100. Further, the computing device 100 may initiate the trusted environment 300 in response to various events such as, for example, system startup, an application request, an operating system request, etc.

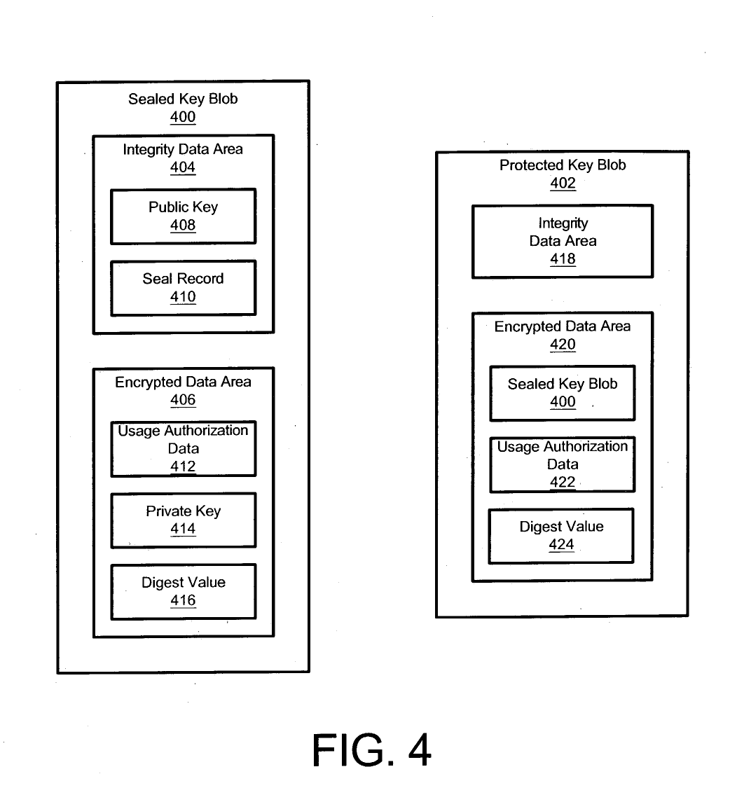

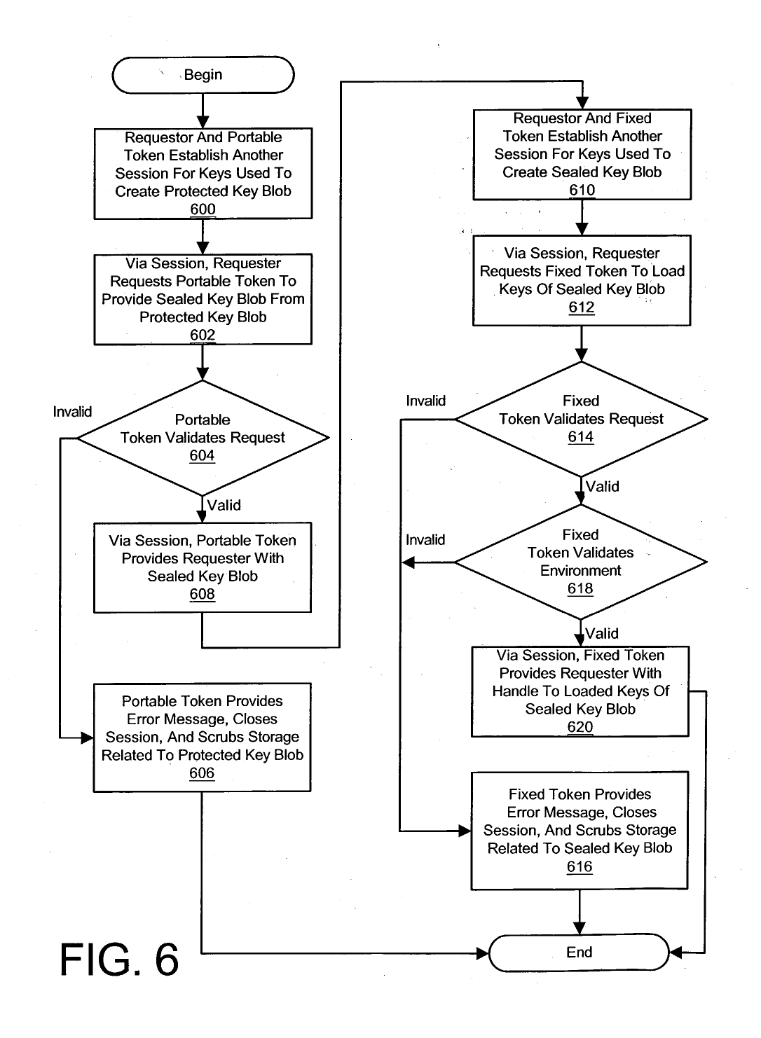

Referring now to FIG. 4, there is shown a sealed key blob 400 and a protected-key blob 402 that may be used for local attestation. As depicted, the sealed key blob 400 may comprise one or more integrity data areas 404 and one or more encrypted data areas 406. The integrity data areas 404 may comprise a public key 408, a seal record 410, and possibly other non-sensitive data such as a blob header that aids in identifying the blob and/or loading the keys of the blob. Further, the encrypted data areas 406 may comprise usage authorization data 412, a private key 414, and a digest value 416. The seal record 410 of the integrity data areas 404 may indicate to which PCR registers 210, corresponding metrics, proof values, and possible other sensitive data the asymmetric key pair 408, 414 was sealed. Further, the digest value 416 may attest to the data of the integrity data areas 404 and may also attest to the data of the encrypted data areas 406 to help prevent attacks obtaining access to data of the encrypted data areas 406 by altering one or more portions of the sealed key blob 400. In one embodiment, the digest value 416 may be generated by performing a hash of the integrity data areas 404, the usage authorization data 412, and the private key 414. In one embodiment, data is stored in the integrity data areas 404 in a plain-text or not encrypted form thus allowing the data of the integrity data area to be read or changed without requiring a key to decrypt the data. Further, the data of the encrypted data areas 406 in one embodiment is encrypted with a public key 206 of the fixed token 110. As is described in more detail in regard to FIG. 6, a requesting component is unable to successfully load the asymmetric key pair 408, 414 of the sealed key blob 400 into the fixed token 110 without establishing a session with the fixed token 110 to use the private key 206 corresponding to the public key 206 used to encrypt the data. Further, the requesting component is unable to successfully load the asymmetric key pair 408, 416 without providing the fixed token 110 with the usage authorization data 412 or proof of having the usage authorization data 412 for the sealed key blob 400 and the environment satisfying criteria specified by the seal record 410.

The protected key blob 402 may comprise one or more integrity data areas 418 and one or more encrypted data areas 420. The integrity data areas 418 may comprise non-sensitive data such as a blob header that aids in identifying the blob. Further, the encrypted data areas 420 may comprise usage authorization data 422, the sealed key blob 400, and a digest value 424. The digest value 424 may attest to the data of the integrity data areas 418 and may also attest to the data of the encrypted data areas 420 to help prevent attacks obtaining access to data of the encrypted data areas 420 by altering one or more portions of the protected key blob 402. In one embodiment, the digest value 424 may be generated by performing a hash of the integrity data areas 418, the sealed key blob 400, and the usage authorization data 422. In one embodiment, data is stored in the integrity data areas 418 in a plain-text or not encrypted form thus allowing the data of the integrity data area to be read or changed without requiring a key to decrypt the data. Further, the data of the encrypted data areas 420 in one embodiment is encrypted with a public key 216 of the portable token 112. As is described in more detail in regard to FIG. 6, a requesting component is unable to successfully obtain the sealed key blob 400 from the protected key blob 402 without establishing a session with the portable token 112 to use the corresponding private key 216. Further, the requesting component is unable to successfully obtain the sealed key blob 400 without providing the portable token 112 with the usage authorization data 422 or proof of having the usage authorization data 422 for the protected key blob 402.

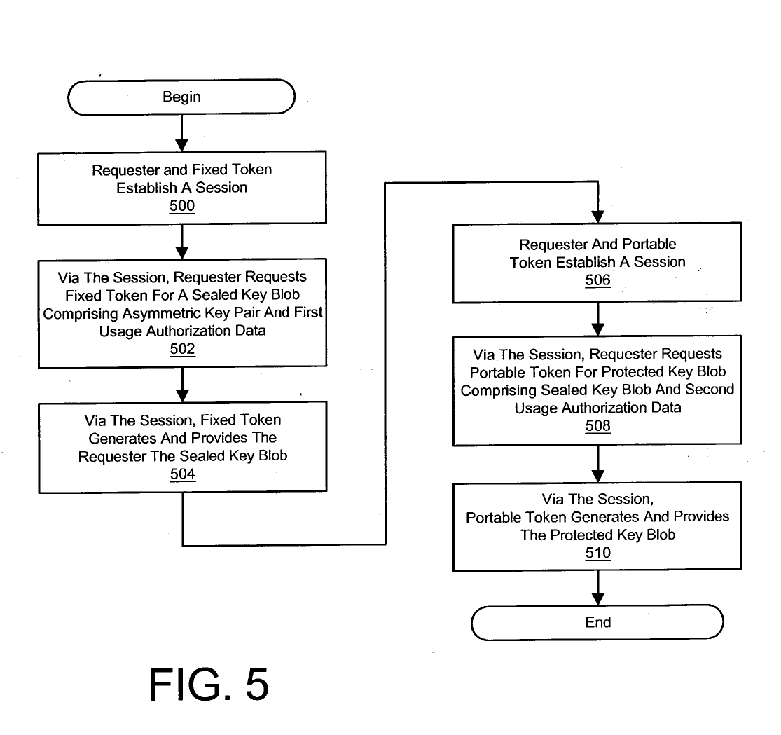

Referring now to FIG. 5 and FIG. 6, there is shown a method to create a protected key blob 402 and a method to use the sealed key blob. In general, the methods of FIG. 5 and FIG. 6 are initiated by a requester. In order to simplify the following description, the requester is assumed to be the monitor 302. However, the requester may be other modules such as, for example, the trusted kernel 312 and/or trusted applets 314 under the permission of the monitor 302. Further, the following assumes the requester and the tokens 110, 112 already have one or more key handles that identify keys 206, 218 stored in protected storage 204, 214 and associated usage authorization data. For example, the requester and the tokens 110, 112 may have obtained such information as a result of previously executed key creation and/or key loading commands. In particular, the following assumes that the requester is able to successfully establish sessions to use key pairs of the tokens 110, 112. However, it should be appreciated that if the requester is not authorized to use the key pairs then the requester will be unable to establish the sessions, and therefore will be unable to generate the respective key blobs using such key pairs and will be unable to load key pairs of key blobs created with such key pairs.

In FIG. 5, a method to generate the sealed key blob of FIG. 4 is shown. In block 500, the monitor 302 and the fixed token 110 may establish a session for an asymmetric key pair of the fixed token 110 that comprises a private key 206 and a corresponding public key 206 stored in protected storage 204 of the fixed token 110. In block 502, the monitor 302 may request via the established session that the fixed token 110 create a sealed key blob 400. In particular, the monitor 302 may provide the fixed token 110 with usage authorization data 412 for the sealed key blob 400. Further, the monitor 302 may provide the fixed token 110 with one or more indexes or identifiers that identify PCR registers 210 to which the fixed token 110 is to seal the keys 408, 414 of the sealed key blob 400 and may provide the fixed token 110 with metrics that are expected to be stored in identified PCR registers 210

The fixed token 110 in block 504 may create and return the requested sealed key blob 400. In particular, the fixed token 110 may generate a asymmetric key pair 408, 414 comprising a private key 414 and a corresponding public key 408 and may store the asymmetric key pair 408, 414 in its protected storage 204. Further, the fixed token 110 may seal the asymmetric key pair 408, 414 and the usage authorization data 412 to an environment specified by metrics of the PCR registers 210 that were identified by the monitor 302. As a result of sealing, the fixed token 110 may generate a seal record 410 that identifies PCR registers 210, metrics of the identified PCR registers 210, a proof value, and a digest value 416 that attests to asymmetric key pair 408, 414, the usage authorization data 412, and the seal record 410. The fixed token 110 may further create the encrypted data areas 406 of the sealed key blob 400 by encrypting the private key 414, the usage authorization data 412, the digest value 416, and any other sensitive data of the sealed key blob 400 with the public key 206 of the established session. By creating the encrypted data areas 406 with the public key 206 of the session, the fixed token 110 may prevent access to the data of the encrypted data areas 406 since such data may only be decrypted with the corresponding private key 206 which is under the control of the fixed token 110. The fixed token 110 may then return to the monitor 302 the requested sealed key blob 400.

In block 506, the monitor 302 and the portable token 112 may establish a session for an asymmetric key pair that comprises a private key 218 and a corresponding public key 218 stored in protected storage 216 of the portable token 112. The monitor 302 in block 508 may request via the established session that the portable token 112 generate from the sealed key blob 400 a protected key blob 402 which has usage authorization data 422. In particular, the monitor 302 may provide the portable token 112 with the sealed key blob 400 and the usage authorization data 422.

The portable token 112 in block 510 may create and return the requested protected key blob 402. In particular, the portable token 112 may seal the usage authorization data 422 and the sealed key blob 400 to the portable token 112. As a result of sealing, the portable token 112 may generate a digest value 424 that attests to the usage authorization data 422 and the sealed key blob 400. The portable token 112 may further create encrypted data areas 420 by encrypting the usage authorization data 422, the sealed key blob, the digest value 424, and any other sensitive data of the protected key blob 402 with the public key 218 of the established session. By creating the encrypted data areas 420 with the public key 218 of the session, the portable token 112 may prevent access to the data of the encrypted data areas 420 since such data may only be decrypted with the corresponding private key 218 which is under the control of the portable token 112. The portable token 112 may then return to the monitor 302 the requested protected key blob 402.

Referring now to FIG. 6, there is shown a method of loading the asymmetric key pair 408, 414 of the protected key blob 402. In block 600, the monitor 302 and portable token 112 may establish a session for the asymmetric key pair of the portable token 112 that was used to create the protected key blob 402. In block 602, the monitor 302 may request the portable token 112 to return the sealed key blob 400 stored in the protected key blob 402. To this end, the monitor 302 may provide the portable token 112 with the protected key blob 402 and an authentication code that provides proof of possessing or having knowledge of the usage authorization data 422 for the protected key blob 402. The monitor 302 may provide the portable token 112 with the authentication code in a number of different manners. In one embodiment, the monitor 302 may simply encrypt its copy of the usage authorization data 422 using the public key 218 of the established session and may provide the portable token 112 with the encrypted copy of its usage authorization data 422.

In another embodiment, the monitor 302 may generate a message authentication code (MAC) that provides both proof of possessing the usage authorization data 422 and attestation of one or more parameters of the request. In particular, the monitor 302 may provide the portable token 112 with a MAC resulting from applying the HMAC algorithm to a shared secret comprising or based upon the second usage authorization data and a message comprising one or more parameters of the request. The HMAC algorithm is described in detail in Request for Comments (RFC) 2104 entitled “HMAC: Keyed-Hashing for Message Authentication.” Basically, the HMAC algorithm utilizes a cryptographic hash function such as, for example, the MD5 or SHA-1 algorithms to generate a MAC based upon a shared secret and the message being transmitted. In one embodiment, the monitor 302 and portable token 112 may generate a shared secret for the HMAC calculation that is based upon the second usage authorization data and rolling nonces generated by the monitor 302 and the portable token 112 for the established session. Moreover, the monitor 302 may generate one or more hashes of the parameters of the request and may compute the MAC via the HMAC algorithm using the computed shared secret and the parameter hashes as the message.

In block 604, the portable token 112 may validate the protected key blob 402 and the request for the sealed key blob 400. In one embodiment, the portable token 112 may compute the authentication code that the portable token 112 expects to receive from the monitor 302. In particular, the portable token 112 may decrypt the protected key blob 402 to obtain the sealed key blob 400 and the usage authorization data 422 for the protected key blob 402. The portable token 112 may then compute the authentication code or MAC in the same manner as the monitor 302 using the parameters received from the request and the usage authorization data 422 obtained from the protected key blob 402. In response to determining that the computed authentication code or MAC does not have the predetermined relationship (e.g. equal) to the authentication code or MAC received from the monitor 302, the portable token 112 may return an error message, may close the established session, may scrub the protected key blob 402 and associated data from the portable token 112, and may deactivate the portable token 112 in block 606. Further, the portable token 112 in block 604 may verify that protected key blob 402 has not been altered. In particular, the portable token 112 may compute a digest value based upon the usage authorization data 422 and the sealed key blob 400 and may determine whether the computed digest value has a predetermined relationship (e.g. equal) to the digest value 424 of the protected key blob 402. In response to determining that the computed digest value does not have the predetermined relationship, the portable token 112 may return an error message, may close the established session, may scrub the protected key blob 402 and associated data from the portable token 112, and may deactivate the portable token 112 in block 604.

In response to determining that the request is valid, the portable token 112 in block 608 may provide the monitor 302 with the sealed key blob 400. The monitor 302 and the fixed token 110 may then establish in block 610 a session for the asymmetric key of the fixed token 110 that was used to create the sealed key blob 400. In block 612, the monitor 302 may request that the fixed token 110 load the asymmetric key pair 408, 414 of the sealed key blob 400. To this end, the monitor 302 may provide the fixed token 110 with the sealed key blob 400 and an authentication code or MAC that provides proof of possessing or having knowledge of the usage authorization data 412 associated with the sealed key blob 400. In one embodiment, the monitor 302 may provide the fixed token 110 with a MAC resulting from an HMAC calculation using a shared secret based upon the usage authorization data 412 in a manner as described above in regard to block 602.

In block 614, the fixed token 110 may validate the request for loading the asymmetric key pair 408, 414 of the sealed key blob 400. In one embodiment, the fixed token 110 may compute the authentication code that the fixed token 110 expects to receive from the monitor 302. In particular, the fixed token 110 may decrypt the sealed key blob 400 using the private key 206 of the established session to obtain the asymmetric key pair 408, 414, the usage authorization data 412, the seal record 410, and the digest value 416 of the sealed key blob 400. The fixed token 110 may then compute the authentication code or MAC in the same manner as the monitor 302 using the parameters received from the request and the first usage authorization data obtained from the first sealed key blob. In response to determining that the computed authentication code or MAC does not have the predetermined relationship (e.g. equal) to the authentication code or MAC received from the monitor 302, the fixed token 110 may return an error message, may close the established session, may scrub the first sealed key blob and associated data from the fixed token 110, and may deactivate the portable token 112 in block 616. Further, the fixed token 110 in block 614 may verify that sealed key blob 400 has not been altered. In particular, the fixed token 110 may compute a digest value based upon the usage authorization data 412, the asymmetric key pair 408, 414, and the seal record 410 and may determine whether the computed digest value has a predetermined relationship (e.g. equal) to the digest value 416 of the sealed key blob 400. In response to determining that the computed digest value does not have the predetermined relationship, the fixed token 110 may return an error message, may close the established session, may scrub the sealed key blob 400 and associated data from the fixed token 110, and may deactivate the portable token 112 in block 616.

The fixed token 110 in block 618 may further verify that the environment 300 is appropriate for loading the asymmetric key 408 of the sealed key blob 400. In particular, the fixed token 110 may determine whether the metrics of the seal record 410 have a predetermined relationship (e.g. equal) to the metrics of the PCR registers 210 and may determine whether the proof value of the seal record 410 indicates that the fixed token 110 created the sealed key blob 400. In response to determining that the metrics of the seal record 410 do not have the predetermined relationship to the metrics of the PCR registers 210 or determining that the fixed token 110 did not create the sealed key blob 400, the fixed token 110 may return an error message, may close the established session, may scrub the sealed key blob 400 and associated data from the fixed token 110, and may deactivate the portable token 112 in block 616.

In response to determining that the request and environment are valid, the fixed token 110 in block 620 may provide the monitor 302 with the public key 408 of the sealed key blob 400 and a key handle to reference the asymmetric key pair 408, 414 stored in protected storage 204 of the fixed token 110. The monitor 302 may later provide the key handle to the fixed token 110 to establish a session to use the asymmetric key pair 408, 414 identified by the key handle.

The methods of FIG. 5 and FIG. 6 in general result in establishing an asymmetric key pair that may be used only if the portable token 112 is present and optionally the environment 300 is appropriate as indicated by the metrics of the PCR registers 210. The computing device 100 and/or remote agents 118₁ . . . 118_{R} therefore may determine that the user of the portable token 112 is present based upon whether the keys 408 of the sealed key blob 400 are successfully loaded by the fixed token 110 and/or the ability to decrypt a secret that may only be decrypted by the keys 408 of the sealed key blob 400.

Further, the user may use the portable token 112 to determine that the computing device 100 satisfies the environment criteria to which the keys 408 of the sealed key blob 400 were sealed. In particular, the user may determine that computing device 100 satisfies the environment criteria based upon whether the keys 408 of the sealed key blob 400 are successfully loaded by the fixed token 110 and/or the ability to decrypt a secret that may only be decrypted by the keys 408 of the sealed key blob 400.

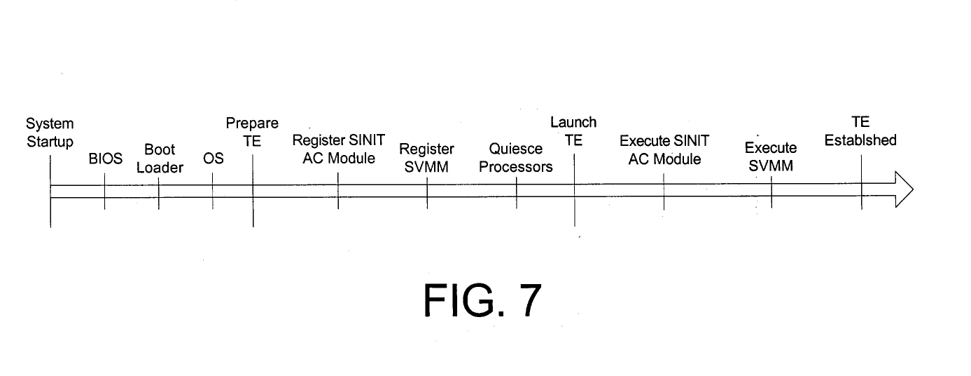

In FIG. 7, there is shown an example timeline for establishing a trusted environment 300. For convenience, the BIOS, monitor 302, operating system 308, application(s) 310, trusted kernel 312, and/or applet(s) 314 may be described as performing various actions. However, it should be appreciated that such actions may be performed by one or more of the processors 102₁ . . . 102_{P} executing instructions, functions, procedures, etc. of the respective software/firmware component. As shown by the example timeline, establishment of a trusted environment may begin with the computing device 100 entering a system startup process. For example, the computing device 100 may enter the system startup process in response to a system reset or system power-up event. As part of the system startup process, the BIOS may initialize the processors 102₁ . . . 102_{P}, the chipset 104, and/or other hardware components- of the computing device 100. In particular, the BIOS may program registers of the processor 102 and the chipset 104. After initializing the hardware components, the BIOS may invoke execution of the operating system 308 or an operating system boot loader that may locate and load the operating system 308 in the memory 106. At this point, an untrusted environment has been established and the operating system 308 may execute the applications 310 in the untrusted environment.

In one embodiment, the computing device 100 may launch the trusted environment 300 in response to requests from the operating system 308 and/or applications 310 of the untrusted environment. In a particular, the computing device 100 in one embodiment may delay invocation of the trusted environment until services of the trusted environment 300 are needed. Accordingly, the computing device 100 may execute applications in the untrusted environment for extended periods without invoking the trusted environment 300. In another embodiment, the computing device 100 may automatically launch the trusted environment as part of the system start-up process.

At any rate, the computing device 100 may prepare for the trusted environment 300 prior to a launch request and/or in response to a launch request. In one embodiment, the operating system 308 and/or the BIOS may prepare for the trusted environment as part of the system start-up process. In another embodiment, the operating system 308 and/or the BIOS may prepare for the trusted environment 300 in response to a request to launch the trusted environment 300 received from an application 310 or operating system 308 of the untrusted environment. Regardless, the operating system 308 and/or the BIOS may locate and load an SINIT authenticated code (AC) module in the memory 106 and may register the location of the SINIT AC module with the chipset 104. The operating 308 and/or the BIOS may further locate and load an SVMM module used to implement the monitor 302 in virtual memory, may create an appropriate page table for the SVMM module, and may register the page table location with the chipset 104. Further, the operating system 308 and/or the BIOS may quiesce system activities, may flush caches of the processors 102₁ and ¹⁰²_{P}, and may bring all the processors 102₁ . . . 102_{P} to a synchronization point.

After preparing the computing device 100, the operating system 308 and/or BIOS may cause one of the processors 102₁ . . . 102_{P} to execute an SENTER instruction which results in the processor 102 invoking the launch of the trusted environment 300. In particular, the SENTER instruction in one embodiment may result in the processor 102 loading, authenticating, measuring, and invoking the SINIT AC module. In one embodiment, the SENTER instruction may further result in the processor 102 hashing the SINIT AC module to obtain a metric of the SINIT AC module and writing the metric of the SINIT AC module to a PCR register 210 of the fixed token 110. The SINIT AC may perform various tests and actions to configure and/or verify the configuration of the computing device 100. In response to determining that the configuration of the computing device 100 is appropriate, the SINIT AC module may hash the SVMM module to obtain a metric of the SVMM module, may write the metric of the SVMM to a PCR register 210 of the fixed token 110, and may invoke execution of the SVMM module. The SVMM module may then complete the creation of the trusted environment 300 and may provide the other processors 102₁ . . . 102_{P} with an entry point for joining the trusted environment 300. In particular, the SVMM module in one embodiment may locate and may load a root encryption key of the monitor 302. Further, the monitor 302 in one embodiment is unable to decrypt any secrets of a trusted environment 300 protected by the root encryption key unless the SVMM module successfully loads root encryption key.

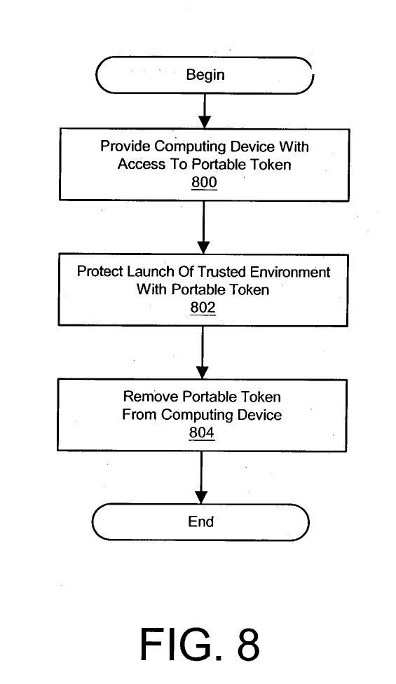

A method is illustrated in FIG. 8 that protects the launch of the trusted environment 300 with a portable token 112. In general, the method prevents the computing device 100 from establishing the trusted environment 300 if the appropriate portable token 112 is not present. A user may seal secrets to a trusted, environment 300 that may not be re-established without the presence of his portable token 112. Accordingly, the user may trust that the computing device 100 will not unseal such secrets without the presence of his portable token 112 since the computing device 100 will be unable to re-establish the trusted environment 300 needed to unseal the secrets. By protecting and maintaining control over the portable token 112 and who uses the portable token 112 with the computing device 100, the user may further protect his secrets from unauthorized access. Similarly, assuming the user maintains control of the portable token 112, the computing device 100 and/or remote agents 118₁ . . . 118_{R} may determine that the user of the portable token 112 is present based upon the presence of the portable token 112.

In block 800, a user may connect his portable token 112 with the computing device 100. In one embodiment, the user may insert his portable token 112 into a slot or plug of the portable token interface 122. In another embodiment, the user may activate a wireless portable token 112 within range of the portable token interface 122. The user may activate the portable token 112 by activating a power button, entering a personal identification number, entering a password, bringing the portable token 112 within proximity of the portable token interface 122, or by some other mechanism.

The computing device 100 in block 802 may protect a trusted environment 300 with the portable token 112. As shown in the timeline of FIG. 7, the computing device 100 may perform a chain of operations in order to establish a trusted environment 300. Accordingly, if the portable token 112 is required anywhere in this chain of operations, then a user may use his portable token 112 to protect the trusted environment 112 from unauthorized launch. In one embodiment, the computing device 100 may encrypt the SVMM module or a portion of the SVMM module using a public key 206 of the fixed token 110 and may generate a protected key blob 402 comprising the public key 206 and its corresponding private key 206 that are sealed to the portable token 112 in the manner described in FIGS. 5 and 6. Accordingly, in such an embodiment, the computing device 100 is prevented from successfully launching the monitor 302 of the SVMM module without the portable token 112 since the computing device 100 is unable to decrypt the SVMM module without the private key 206 that was sealed to the portable token 112.

However, the computing device 100 in block 802 may protect the trusted environment 300 in various other manners. In one embodiment, the computing device 100 may protect the trusted environment 300 earlier in the chain of operations. In particular, the computing device 100 may encrypt the BIOS, operating system 308, boot loader, SINIT AC module, portions thereof, and/or some other software/firmware required by the chain of operations in the manner described above in regard to encrypting the SVMM module or a portion thereof. In yet another embodiment, the computing device 100 may simply store in the portable token 112 the BIOS, a boot loader the operating system 308, the SINIT AC module, portions thereof, and/or other software/firmware that are required to successfully launch the trusted environment 300. Similarly, the computing device 100 may store in the portable token 112 the SVMM module or a portion thereof that is required to successfully launch the trusted environment 300, thus requiring the presence of the portable token 112 to reconstruct the SVMM module and launch the trusted environment 300. Further, the computing device 100 may store in the portable token 112 the root encryption key of the monitor 302 or a portion thereof that is required to decrypt secrets of a trusted environment 300 and is therefore required to successfully launch the trusted environment 300.

In block 804, the user may remove the portable token 112 from the computing device 100. In one embodiment, the user may remove his portable token 112 from a slot or plug of the portable token interface 122. In another embodiment, the user may remove a wireless portable token 112 by de-activating the portable token 112 within range of the portable token interface 122. The user may de-activate the portable token 112 by de-activating a power button, re-entering a personal identification number, re-entering a password, moving the portable token 112 out of range of the portable token interface 122, or by some other mechanism.

The computing device 100 may perform all or a subset of the operations shown in FIGS. 5-8 in response to executing instructions of a machine readable medium such as, for example, read only memory (ROM); random access memory (RAM); magnetic disk storage media; optical storage media; flash memory devices; and/or electrical, optical, acoustical or other form of propagated signals such as, for example, carrier waves, infrared signals, digital signals, analog signals. Furthermore, while FIGS. 5-8 illustrate a sequence of operations, the computing device 100 in some embodiments may perform various illustrated operations in parallel or in a different order.

While certain features of the invention have been described with reference to example embodiments, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising storing, on a portable token, information that is required by a computing device in order to successfully launch a trusted environment.

2. The method of claim 1, wherein the information comprises one or more portions of a module that comprises a monitor of the trusted environment.

3. The method of claim 1, wherein the information comprises one or more portions of an authenticated code module that is required in order to launch the trusted environment.

4. The method of claim 1, wherein the information comprises one or more keys that are required in order to launch the trusted environment.

5. The method of claim 1, wherein the information comprises a root key that is required by a monitor of the trusted environment to decrypt secrets of the trusted environment.

6. The method of claim 1, wherein the information comprises one or more portions of BIOS firmware.

7. The method of claim 1, further comprising connecting the portable token to a portable token interface of the computing device prior to storing the information.

8. The method of claim 7, further comprising removing the portable token from the portable token interface after storing the information.

9. A method comprising
generating a key blob comprising a key pair that is sealed to a portable token, and
encrypting, with the key pair, information that is required by a computing device in order to successfully launch a trusted environment.

10. The method of claim 9, wherein the information comprises one or more portions of a module that comprises a monitor of the trusted environment.

11. The method of claim 9, wherein the information comprises one or more portions of an authenticated code module that is required in order to launch the trusted environment.

12. The method of claim 9, wherein the information comprises one or more portions of BIOS firmware.

13. The method of claim 9, further comprising connecting the portable token to a portable token interface of the computing device prior to generating the key blob.

14. The method of claim 13, further comprising removing the portable token from the portable token interface after generating the key blob.

15. A machine readable medium comprising a plurality of instructions that, in response to being executed, results in a computing device
determining whether a user is present, and
launching a trusted environment only in response to determining that the user is present.

16. The machine readable medium of claim 15 wherein the plurality of instructions, in response to being executed, further results in the computing device determining that the user is present in response to determining that a portable token associated with the user is present.

17. The machine readable medium of claim 16 wherein the plurality of instructions, in response to being executed, further results in the computing device decrypting information required to launch the trusted environment with a key that was sealed to the portable token.

18. The machine readable medium of claim 17 wherein the information comprises one or more portions of a monitor of the trusted environment.

19. The machine readable medium of claim 17 wherein the information comprises one or more portions of an authenticated code module that is required in order to launch the trusted environment.

20. The machine readable medium of claim 17 wherein the information comprises one or more portions of BIOS firmware.

21. The machine readable medium of claim 16 wherein the plurality of instructions, in response to being executed, further results in the computing device obtaining, from the portable token, information required to launch the trusted environment.

22. The machine readable medium of claim 21 wherein the information comprises one or more portions of a monitor of the trusted environment.

23. The machine readable medium of claim 21 wherein the information comprises one or more portions of an authenticated code module that is required in order to launch the trusted environment.

24. The machine readable medium of claim 21 wherein the information comprises one or more keys that are required in order to launch the trusted environment.

25. The machine readable medium of claim 21 wherein the information comprises a root key that is required by a monitor of the trusted environment to decrypt secrets of the trusted environment.

26. The machine readable medium of claim 21 wherein the information comprises one or more portions of BIOS firmware.

27. A computing device comprising
a volatile memory,
a portable token interface,
a chipset coupled to the portable token interface and the volatile memory, the chipset to define one or more portions of the volatile memory as protected memory, and
a processor to launch a trusted environment in the protected memory only if the portable token interface has been in communication with an appropriate portable token.

28. The computing device of claim 27 wherein the appropriate portable token comprises one or more portions of a monitor of the trusted environment.

29. The computing device of claim 27 wherein the appropriate portable token comprises one or more portions of an authenticated code module that is required in order to launch the trusted environment.

30. The computing device of claim 27 wherein the appropriate portable token comprises one or more keys that are required in order to launch the trusted environment.

31. The computing device of claim 27 wherein the appropriate portable token comprises a root key that is required by a monitor of the trusted environment to decrypt secrets of the trusted environment.

32. The computing device of claim 27 wherein the processor is only able to decrypt information required to launch the trusted computing device if the portable token interface has been in communication with the appropriate portable token.
